(19) United States
(12) Patent Application Publication
(10) Pub. No.: US 2026/0098999 A1
(43) Pub. Date: Apr. 9, 2026

(54) HETEROGENEOUS DIAMOND/SILICON CARBIDE PHOTONIC INTEGRATED CIRCUIT

(71) Applicant: RTX BBN Technologies, Inc., Cambridge, MA (US)

(72) Inventors: Erik Eisenach, Cambridge, MA (US); Milica Notaros, Arlington, MA (US); Moe D. Soltani, Belmont, MA (US)

(21) Appl. No.: 19/350,809

(22) Filed: Oct. 6, 2025

Related U.S. Application Data
(60) Provisional application No. 63/703,772, filed on Oct. 4, 2024.

(51) Int. Cl. G02B 6/12; G02B 6/10

(52) U.S. Cl. CPC G02B 6/12004; G02B 6/102; G02B 2006/12061; G02B 2006/12109; G02B 2006/12138; G02B 2006/12147; G02B 2006/12159

(57) ABSTRACT

A sensor may include a light source to generate pump light, a substrate including optically-addressable defects, and one or more waveguides on the substrate to receive the pump light. An optical mode profile of the pump light in the one or more waveguides may extend into the substrate to excite at least a portion of the optically-addressable defects in the substrate, where photoemission from the optically-addressable defects is coupled into the one or more waveguides. The sensor may further include one or more detectors configured to generate detection signals based on the photoemission from the one or more optical waveguides.

### CROSS-REFERENCE TO RELATED APPLICATION

The present application claims the benefit under 35 U.S.C. § 119(e) of U.S. Provisional Application Serial Number 63/703,772 filed October 4, 2024, entitled HETEROGENEOUS DIAMOND/SILICONCARBIDE PHOTONIC INTEGRATED CIRCUIT, naming Erik Eisenach, Milica Notaros, and Moe D. Soltani as inventors, which is incorporated herein by reference in the entirety.

### TECHNICAL FIELD

The present disclosure relates generally to quantum sensors and, more particularly, to a compact photonic integrated circuit (PIC) quantum sensor platform.

### BACKGROUND

Sensors that generate measurements based on solid-state spin states are a promising technology for many applications including, but not limited to, room-temperature measurements of electric fields, magnetic, strain, or temperature. However, existing technologies typically utilize bulk components that require precise alignment and often have inflexible architectures. Further, existing technologies may have low sensitivity due to challenges associated with input and/or output coupling. For example, spin state measurements of nitrogen vacancy centers in diamond has emerged as a promising sensing technology. In particular, photoemission of excited NV centers may be sensitive to spin states of the NV centers and thus sensitive to properties of interest for a measurement. However, the high refractive index of diamond presents challenges for coupling pump light and/or photoemission when using typical sensor configurations. There is therefore a need to develop systems and methods to address the above deficiencies.

### SUMMARY

In embodiments, the techniques described herein relate to a sensor including a light source configured to generate pump light; a substrate including optically-addressable defects; one or more waveguides disposed on the substrate and configured to receive the pump light, where an optical mode profile of the pump light in the one or more waveguides extend into the substrate to excite at least a portion of the optically-addressable defects in the substrate, where photoemission from the optically-addressable defects is coupled into the one or more waveguides; and one or more detectors configured to generate detection signals based on the photoemission from the one or more waveguides.

In embodiments, the techniques described herein relate to a sensor, where the substrate includes diamond, where the optically-addressable defects include nitrogen vacancy centers.

In embodiments, the techniques described herein relate to a sensor, where the one or more waveguides are formed from silicon carbide.

In embodiments, the techniques described herein relate to a sensor, where the pump light includes a wavelength in a range of 510 to 580 nanometers.

In embodiments, the techniques described herein relate to a sensor, where the photoemission from the optically-addressable defects includes fluorescence.

In embodiments, the techniques described herein relate to a sensor, further including one or more filters to filter the pump light from the one or more waveguides.

In embodiments, the techniques described herein relate to a sensor, where the one or more filters include at least one of an evanescent waveguide coupler, an unbalanced Mach-Zender interferometer, or a resonator-based filter.

In embodiments, the techniques described herein relate to a sensor, where the light source is formed on the substrate.

In embodiments, the techniques described herein relate to a sensor, where the light source is external to the substrate.

In embodiments, the techniques described herein relate to a sensor, where the one or more detectors are formed on the substrate.

In embodiments, the techniques described herein relate to a sensor, where the one or more detectors are external to the substrate.

In embodiments, the techniques described herein relate to a sensor, further including a controller configured to generate one or more measurements based on the detection signals from the one or more detectors.

In embodiments, the techniques described herein relate to a sensor including one or more waveguides disposed on a substrate and configured to receive pump light from a laser source, where an optical mode profile of the pump light in the one or more waveguides extend into the substrate to excite at least a portion of optically-addressable defects in the substrate, where photoemission from the optically-addressable defects is coupled into the one or more waveguides.

In embodiments, the techniques described herein relate to a sensor, where the substrate includes diamond, where the optically-addressable defects include nitrogen vacancy centers, where the one or more waveguides are formed from silicon carbide.

In embodiments, the techniques described herein relate to a sensor, further including one or more filters to filter the pump light from the one or more waveguides.

In embodiments, the techniques described herein relate to a sensor, where the one or more filters include at least one of an evanescent waveguide coupler, an unbalanced Mach-Zender interferometer, or a resonator-based filter.

In embodiments, the techniques described herein relate to a sensor, where the photoemission from the optically-addressable defects includes fluorescence.

In embodiments, the techniques described herein relate to a method including directing pump light into one or more waveguides disposed on a substrate including optically-addressable defects, where an optical mode profile of the pump light in the one or more waveguides extends into the substrate to excite at least a portion of the optically-addressable defects in the substrate; collecting photoemission from the optically-addressable defects that is coupled into the one or more waveguides; and generating detection signals based on the photoemission from the one or more waveguides.

In embodiments, the techniques described herein relate to a method, further including filtering the pump light from the one or more waveguides.

In embodiments, the techniques described herein relate to a method, where the substrate includes diamond, where the optically-addressable defects include nitrogen vacancy centers, where the one or more waveguides are formed from silicon carbide.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of a sensor, in accordance with one or more embodiments of the present disclosure.

FIG. 2 illustrates a cross-sectional view of a photonic integrated circuit (PIC) device depicting a waveguide on a substrate, in accordance with one or more embodiments of the present disclosure.

FIG. 3 illustrates four plots of optical mode profiles of light of different wavelengths within a silicon carbide waveguide on a diamond substrate, in accordance with one or more embodiments of the present disclosure.

FIG. 4 depicts an illustrative plot of engineered photoemission of nitrogen vacancy centers in a diamond substrate in the presence of a waveguide, in accordance with one or more embodiments of the present disclosure.

FIG. 5 illustrates a simplified top view of a PIC device with a filter coupled to a waveguide, in accordance with one or more embodiments of the present disclosure.

FIG. 6 illustrates a method for quantum sensing is described, in accordance with one or more embodiments of the present disclosure.

### DETAILED DESCRIPTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one,” “one or more,” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Embodiments of the present disclosure are directed to systems and methods providing a photonic integrated circuit (PIC) platform for compact quantum sensing. In some embodiments, a sensor includes one or more waveguides patterned onto a substrate (e.g., a solid-state material) designed to promote both excitation of optically-addressable defects in the substrate and couple in photoemission (e.g., fluorescence, or the like) from the optically-addressable defects induced by the pump light. For example, an optical mode profile of pump light in the waveguides may extend into the substrate to excite the optically-addressable defects. An optical mode of the photoemission may also extend into the substrate to promote coupling of the photoemission into the waveguides. In some cases, the waveguides may manipulate the photoemission process by providing an efficient emission pathway such that emission in wavelengths that couple well to the waveguides is promoted. Put another way, the presence of the waveguides may produce engineered emission (e.g., engineered fluorescence) in wavelengths that couple into the waveguides.

The systems and methods disclosed herein may enable sensing based on any type of optically-addressable defects in any substrate such as, but not limited to, quantum sensing based on spin states of nitrogen vacancy (NV) centers in diamond. For example, a sensor as disclosed herein may be formed from one or more silicon carbide (SiC) waveguides patterned onto a diamond substrate.

In some embodiments, the one or more waveguides are patterned on a pristine substrate rather than patterning the substrate directly into waveguides, which may avoid modification of or damage to the defect sites of interest for sensing.

A PIC platform as disclosed herein with combined excitation and readout of optically-addressable defects using waveguides patterned on a pristine substrate may provide numerous benefits. For example, providing both optical excitation and optical readout using waveguides provides a highly compact sensor package relative to techniques utilizing bulk optics for excitation and/or readout. Further, components such as, but not limited to, a laser source, a detector, or filters may also be fabricated directly on the substrate in the PIC platform. As another example, the systems and methods disclosed herein may facilitate efficient coupling of both the pump light into the substrate and the photoemission from the substrate. As an illustration in the case of a diamond substrate, the high refractive index of diamond (e.g., around 2.42) results in high confinement of photoemission when using existing techniques. However, the evanescent coupling of light from diamond into the waveguides (e.g., SiC waveguides) provides efficient collection and extraction of the photoemission.

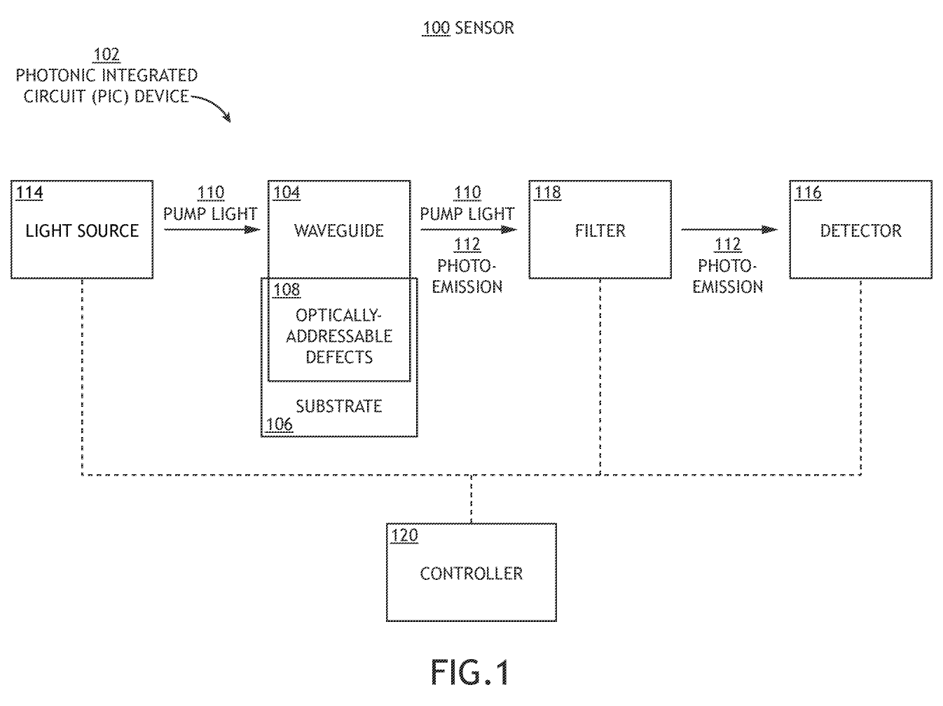

Referring now to FIGS. 1-5, systems and methods providing quantum sensing in a PIC platform are described in greater detail, in accordance with one or more embodiments of the present disclosure.

FIG. 1 illustrates a block diagram of a sensor 100, in accordance with one or more embodiments of the present disclosure.

In some embodiments, the sensor 100 includes a PIC device 102 with one or more waveguides 104 disposed on a substrate 106 including optically-addressable defects 108, where the one or more waveguides 104 are designed to provide both optical excitation of the optically-addressable defects 108 by pump light 110 propagating in the one or more waveguides 104 and collection of photoemission 112 from the optically-addressable defects 108.

The substrate 106 may include any material (e.g., solid-state material) having any type of optically-addressable defects 108 suitable for sensing. In some embodiments, the substrate 106 is diamond and the optically-addressable defects 108 are NV centers. It is recognized herein that NV centers in diamond are a promising platform for room-temperature quantum metrology for a variety of measurements including, but not limited to, temperature, strain, electric field, or magnetic fields. For instance, spin states and transitions of such NV centers that are sensitive to such measured parameters may be manipulated and read out using optical techniques. As an illustration, the NV centers may be optically excited by the pump light 110 propagating in the one or more waveguides 104 and may emit spin-dependent photoemission 112 (e.g., fluorescence) upon relaxation, which may be detected as the basis of a measurement.

The one or more waveguides 104 be formed from any material suitable for guiding light when deposited on the selected substrate 106 such as, but not limited to, dielectric materials, semiconductor materials, or nonlinear materials. In some embodiments, the one or more waveguides 104 are formed as SiC.

In some embodiments, the sensor 100 includes a light source 114 to generate the pump light 110 having spectral content (e.g., one or more wavelengths) suitable for exciting the optically-addressable defects 108. The light source 114 may include any component suitable for generating pump light 110 having spectral components that excite selected optically-addressable defects 108. For example, the light source 114 may include one or more wavelengths in an excitation band of the optically-addressable defects 108. As an illustration in the case of NV centers in a diamond substrate 106, the light source 114 may generate pump light 110 having wavelengths in a spectral range of 510 to 580 nanometers (nm). In some embodiments, the light source 114 is a laser source. Further, the light source 114 may be integrated onto the substrate 106 as part of the PIC device 102 or may be provided as an external component.

In some embodiments, the sensor 100 includes one or more detectors 116 coupled to the one or more waveguides 104 to generate detection signals based on the photoemission 112 collected by the one or more waveguides 104. The detectors 116 may include any optical sensing device suitable for generating detection signals based on incident photoemission 112 such as, but not limited to, one or more photodiodes. Further, the one or more detectors 116 may be integrated onto the substrate 106 as part of the PIC device 102 or may be provided as an external component.

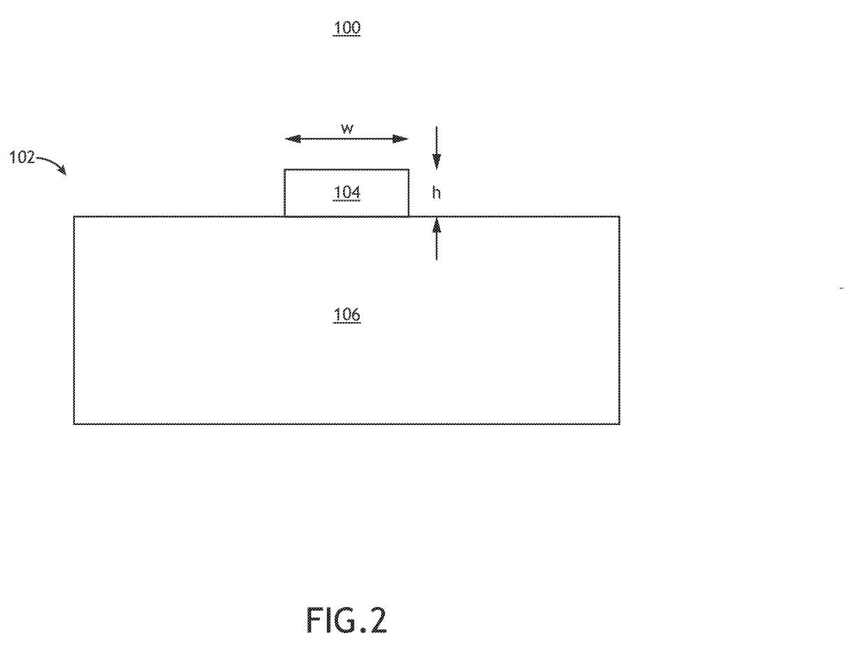

FIGS. 2-4 depict combined excitation of optically-addressable defects 108 and collection of associated photoemission 112 in greater detail, in accordance with one or more embodiments of the present disclosure.

FIG. 2 illustrates a cross-sectional view of a PIC device 102 depicting a waveguide 104 on a substrate 106, in accordance with one or more embodiments of the present disclosure. Although a single waveguide 104 is illustrated in FIG. 2, a PIC device 102 may include any number, types, arrangements, or shapes of waveguides 104 on a substrate 106.

The waveguide 104 may have any geometry, design, or dimensions suitable for guiding both pump light 110 and photoemission 112 when fabricated on the substrate 106. In some embodiments, as shown in FIG. 2, a waveguide 104 is a ridge waveguide. For example, the waveguide 104 may be formed as a strip of material fabricated directly on a pristine (e.g., unpatterned) substrate 106. In this configuration, the optically-addressable defects 108 may be undisturbed by the fabrication of the waveguide 104. Further, although not shown, one or more cladding layers may be fabricated around the waveguide 104 to provide mechanical protection and/or generate a desired optical mode profile of light in the waveguide 104.

In some embodiments, the dimensions of the waveguide 104 such as, but not limited to, the width (w) or the height (h), are designed to provide that optical modes of wavelengths associated with both the pump light 110 and the photoemission 112 extend into the substrate 106 to facilitate interaction with optically-addressable defects 108 in the substrate 106 (e.g., excitation and photoemission 112 coupling).

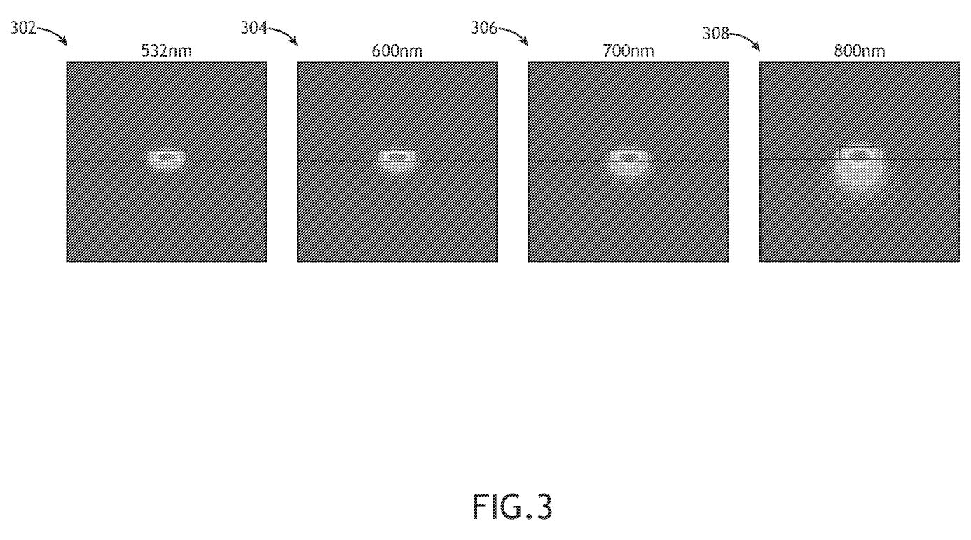

FIG. 3 illustrates four plots of optical mode profiles of light of different wavelengths within a SiC waveguide 104 (refractive index approximately 2.7) on a diamond substrate 106 (refractive index approximately 2.4), in accordance with one or more embodiments of the present disclosure. Plot 302 depicts an optical mode profile of light with a wavelength of 532 nm. Plot 304 depicts an optical mode profile of light with a wavelength of 600 nm. Plot 306 depicts an optical mode profile of light with a wavelength of 700 nm. Plot 308 depicts an optical mode profile of light with a wavelength of 800 nm.

As illustrated in FIG. 3, the optical mode profile of light in such a structure is highly confined to the SiC waveguide 104 around interfaces with air, SiO₂, or any other relatively low-index cladding material, but may extend into the diamond substrate 106. In particular, an evanescent tail of the optical mode profile may extend deeper into the diamond substrate 106 with increasing wavelength. Such a configuration may thus allow for efficient optical interactions between the waveguide 104 and the substrate 106 for wavelengths associated with both the pump light 110 and the photoemission 112. As an illustration, photoemission 112 (e.g., fluorescence) of NV centers in bulk diamond generated in response to excitation with 532 nm pump light 110 may range from approximately 550 nm to 850 nm. It is to be understood, however, that the waveguide 104 is not limited by the wavelengths associated with photoemission 112 and may support propagation of additional wavelengths. In some applications, the waveguide 104 may support propagation of infrared wavelengths such as, but not limited to, wavelengths around 1042 nanometers. In this way, the waveguide 104 may support additional optical interactions with the optically-addressable defects 108 such as, but not limited to, techniques utilizing interferometric readout of phase information of light that is sensitive to the spin state of the optically-addressable defects 108.

In some embodiments, the dimensions of the waveguide 104 such as, but not limited to, the width (w) or the height (h), are designed to balance a depth of the optical mode profile into the substrate 106 (e.g., a depth at which optically-addressable defects 108 are excited by an evanescent tail of pump light 110 propagating in the waveguide 104) with a collection efficiency of the associated photoemission 112 back into the waveguide 104. For example, the dimensions of the waveguide 104 may be designed to provide an optical mode profile of the pump light 110 with a selected percentage of power and/or area within the substrate 106. Similarly, the dimensions of the waveguide 104 may be designed to provide an optical mode profile of the photoemission 112 with a selected percentage of area within the substrate 106. As an illustration, decreasing a height (h) of the waveguide 104 may increase a percentage of the optical mode profile of both the pump light 110 and the photoemission 112 that lies within the substrate 106. However, the collection efficiency of the photoemission 112 may generally decrease with depth in the substrate 106. In this way, the height (h) may be selected to balance excitation of optically-addressable defects 108 with collection efficiency of the photoemission 112.

It is contemplated herein that the waveguide 104 may itself impact the spectrum of photoemission 112 from excited optically-addressable defects 108 by providing an efficient emission pathway. For example, the generation of photoemission 112 may be associated with spontaneous emission of photons from excited states, where the resulting spectrum is influenced by factors such as, but not limited to, a distribution of excited states and probabilities for emission of photons of different energies (e.g., wavelengths). The presence of a waveguide 104 near the optically-addressable defects 108 may distort the probabilities for emission of photons of different wavelengths based on the coupling efficiencies of different wavelengths into the waveguide 104. As a result, the spectrum of the photoemission 112 may favor wavelengths that may be efficiently coupled into the waveguide 104. In some embodiments, the dimensions of the waveguide 104 are designed to promote this engineered emission (e.g., engineered fluorescence).

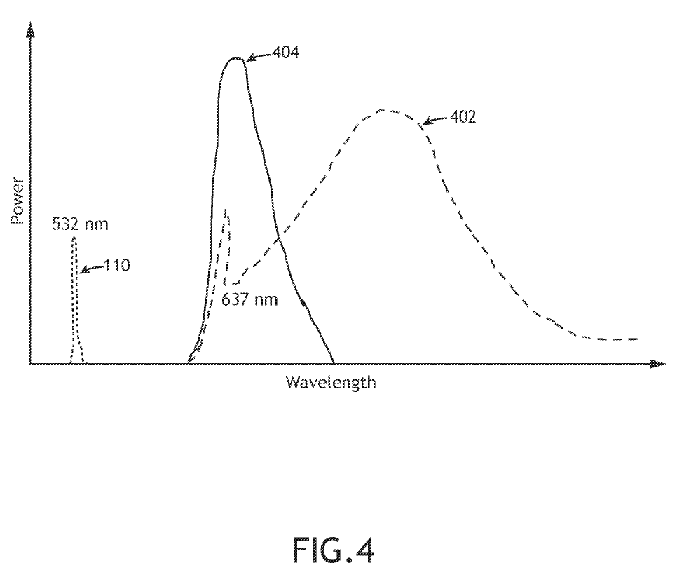

FIG. 4 depicts an illustrative plot of engineered photoemission of NV centers (e.g., optically-addressable defects 108) in a diamond substrate 106 in the presence of a waveguide 104, in accordance with one or more embodiments of the present disclosure. In particular, FIG. 4 depicts an illustration of a spectrum 402 of fluorescence photoemission 112 from NV centers in a bulk diamond substrate 106 in response to 532 nm pump light 110 without a nearby waveguide 104, along with a spectrum 404 of fluorescence photoemission 112 from NV centers in a diamond substrate 106 with a waveguide 104 as depicted in FIG. 2. In FIG. 4, the spectrum 404 associated with engineered fluorescence based on the presence of the waveguide 104 includes more power at lower wavelengths consistent with better optical mode overlap with the waveguide 104 as shown in FIG. 3.

Referring again to FIG. 1, in some embodiments, the sensor 100 includes one or more filters 118 coupled to the one or more waveguides 104 to filter out the pump light 110 and thus prevent or reduce the amount of pump light 110 reaching the one or more detectors 116. The sensor 100 may include any type of filters 118 known in the art suitable for filtering out at least a portion of the pump light 110. For example, the filter 118 may include an evanescent waveguide coupler that is wavelength-selective, an unbalanced Mach-Zender interferometer, or a resonator-based filter. Further, the sensor 100 may include any number of cascaded or multi-stage filters 118.

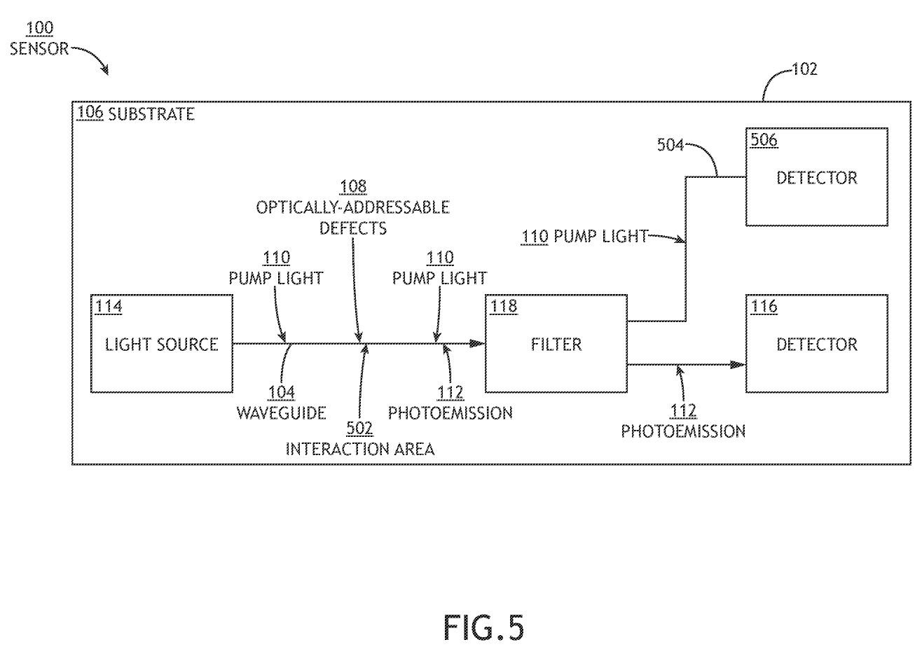

FIG. 5 illustrates a simplified top view of a PIC device 102 with a filter 118 coupled to a waveguide 104, in accordance with one or more embodiments of the present disclosure. For example, FIG. 5 depicts a configuration in which a waveguide 104 extends over an interaction area 502, where pump light 110 from a light source 114 may excite optically-addressable defects 108 and collect photoemission 112 from the detectors 116. In FIG. 5, the filter 118 is then coupled to the waveguide 104 prior to the detector 116 to filter out the pump light 110 and increase a signal to noise ratio of the photoemission 112 on the detector 116.

In some embodiments, the sensor 100 includes at least one filter 118 formed on an output face of a waveguide 104, which may be suitable for configurations in which a corresponding detector 116 is an external component coupled to the substrate 106. For example, such a filter 118 may be formed as a dielectric stack or as micro/nanostructures. In some embodiments, the sensor 100 includes at least one filter 118 formed as an external component.

In some embodiments, as illustrated in FIG. 5, the sensor 100 further includes an additional waveguide 504 to receive the pump light 110 from the filters 118 and an additional detector 506 to capture this filtered pump light 110. Such a configuration may be suitable for, but not limited to, use as a monitor. For example, the filtered light may be used in a balanced detection scheme, where the signal due to the photoemission 112 and the filtered-out pump light 110 are subtracted in order to cancel optical power fluctuations.

Referring again to FIG. 1, in some embodiments, the sensor 100 includes a controller 120. The controller 120 may include one or more processors suitable for executing program instructions stored on a memory device such as, but not limited to, a non-transitory memory device. For instance, the controller 120 may include a digital signal processor (DSP), a field-programmable gate array (FPGA) device, an application-specific integrated circuit (ASIC), a central processing unit (CPU), or a graphical processing unit (GPU).

The controller 120 may be coupled with any components of the sensor 100 such as, but not limited to, the light source 114, the detectors 116, or the filters 118. In this way, the controller 120 may receive data from and/or control (e.g., by generating control signals) any connected components. For example, the controller 120 may receive detection signals from one or more detectors 116 and generate one or more measurements based on the detection signals. As another example, the controller 120 may tune the filters 118 (e.g., by controlling phase shifters therein) to match a wavelength of the pump light 110.

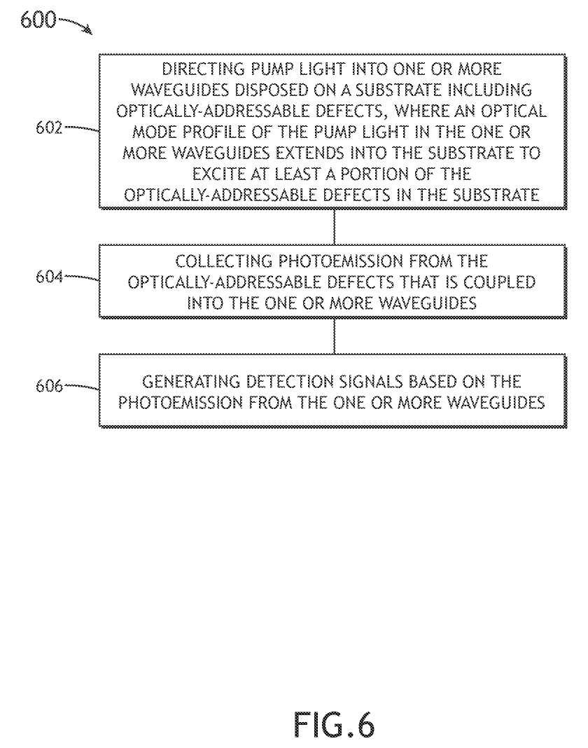

Referring now to FIG. 6, FIG. 6 illustrates a method 600 for quantum sensing is described, in accordance with one or more embodiments of the present disclosure. The embodiments and enabling technologies described previously herein in the context of the sensor 100 should be interpreted to extend to the method 600. For example, the processors of the controller 120 may be configured to execute program instructions stored on the memory, where the program instructions cause the processors to perform any of the steps of the method 600 either directly or indirectly (e.g., by generating control signals to direct another component to perform an action). However, the method 600 is not limited to the architecture of the sensor 100.

The method 600 may include a step 602 of directing pump light into one or more waveguides disposed on a substrate including optically-addressable defects, where an optical mode profile of the pump light in the one or more waveguides extends into the substrate to excite at least a portion of the optically-addressable defects in the substrate. The step 602 may include generating pump light suitable for exciting any type of optically-addressable defects in any substrate material via evanescent excitation. For example, the optically-addressable defects may include, but are not limited to, NV centers in a diamond substrate. Further, the one or more waveguides may have any composition, size, or pattern suitable for providing that the optical mode profile of the pump light extends into the substrate to excite the optically-addressable defects. For example, the one or more waveguides may be formed from silicon carbide with widths and/or heights selected to provide an optical mode profile that extends into a diamond substrate.

The method 600 may include a step 604 of collecting photoemission from the optically-addressable defects that is coupled into the one or more waveguides. For example, the one or more waveguides may be designed to support propagation of wavelengths associated with the photoemission. The photoemission may couple into the one or more waveguides through any mechanism including, but not limited to, evanescent coupling.

The method 600 may include a step 606 of generating detection signals based on the photoemission from the one or more waveguides. For example, a detector may receive the photoemission from the waveguides and generate the detection signals. In this way, the detection signals may provide or be used to provide a measurement based on the received photoemission. As an illustration in the case of NV centers in diamond, the spin states and transitions of such NV centers may be sensitive (e.g., when pumped by the pump light and in some cases microwave radiation) to properties of interest such as, but not limited to, temperature, strain, electric field, or magnetic fields. In particular, the NV centers may be optically excited by the pump light propagating in the one or more waveguides (and in some cases radio frequency signals) and may emit spin-dependent photoemission 112 (e.g., fluorescence) upon relaxation, which may couple into the one or more waveguides and be detected as the basis of a measurement.

Although not shown, the method may further include a step of filtering the pump light from the one or more waveguides. For example, one or more spectral filters may be placed prior to a detector to isolate the photoemission, which may increase the detection sensitivity.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A sensor comprising:
a light source configured to generate pump light;
a substrate including optically-addressable defects;
one or more waveguides disposed on the substrate and configured to receive the pump light, wherein an optical mode profile of the pump light in the one or more waveguides extend into the substrate to excite at least a portion of the optically-addressable defects in the substrate, wherein photoemission from the optically-addressable defects is coupled into the one or more waveguides; and
one or more detectors configured to generate detection signals based on the photoemission from the one or more waveguides.

2. The sensor of claim 1, wherein the substrate comprises diamond, wherein the optically-addressable defects comprise nitrogen vacancy centers.

3. The sensor of claim 2, wherein the one or more waveguides are formed from silicon carbide.

4. The sensor of claim 2, wherein the pump light includes a wavelength in a range of 510 to 580 nanometers.

5. The sensor of claim 2, wherein the photoemission from the optically-addressable defects comprises fluorescence.

6. The sensor of claim 1, further comprising:
one or more filters to filter the pump light from the one or more waveguides.

7. The sensor of claim 6, wherein the one or more filters comprise:
at least one of an evanescent waveguide coupler, an unbalanced Mach-Zender interferometer, or a resonator-based filter.

8. The sensor of claim 1, wherein the light source is formed on the substrate.

9. The sensor of claim 1, wherein the light source is external to the substrate.

10. The sensor of claim 1, wherein the one or more detectors are formed on the substrate.

11. The sensor of claim 1, wherein the one or more detectors are external to the substrate.

12. The sensor of claim 1, further comprising:
a controller configured to generate one or more measurements based on the detection signals from the one or more detectors.

13. A sensor comprising:
one or more waveguides disposed on a substrate and configured to receive pump light from a laser source, wherein an optical mode profile of the pump light in the one or more waveguides extend into the substrate to excite at least a portion of optically-addressable defects in the substrate, wherein photoemission from the optically-addressable defects is coupled into the one or more waveguides.

14. The sensor of claim 13, wherein the substrate comprises diamond, wherein the optically-addressable defects comprise nitrogen vacancy centers, wherein the one or more waveguides are formed from silicon carbide.

15. The sensor of claim 13, further comprising:
one or more filters to filter the pump light from the one or more waveguides.

16. The sensor of claim 15, wherein the one or more filters comprise:
at least one of an evanescent waveguide coupler, an unbalanced Mach-Zender interferometer, or a resonator-based filter.

17. The sensor of claim 13, wherein the photoemission from the optically-addressable defects comprises fluorescence.

18. A method comprising:
directing pump light into one or more waveguides disposed on a substrate including optically-addressable defects, wherein an optical mode profile of the pump light in the one or more waveguides extends into the substrate to excite at least a portion of the optically-addressable defects in the substrate;
collecting photoemission from the optically-addressable defects that is coupled into the one or more waveguides; and
generating detection signals based on the photoemission from the one or more waveguides.

19. The method of claim 18, further comprising:
filtering the pump light from the one or more waveguides.

20. The method of claim 18, wherein the substrate comprises diamond, wherein the optically-addressable defects comprise nitrogen vacancy centers, wherein the one or more waveguides are formed from silicon carbide.
